(19) United States
(12) Patent Application Publication
(10) Pub. No.: US 2026/0006388 A1
(43) Pub. Date: Jan. 1, 2026

(54) Vehicle Component With a Surface Comprising Piezoelectric Transducer Fibers

(71) Applicant: Bayerische Motoren Werke Aktiengesellschaft, Muenchen (DE)

(72) Inventor: Stefan HEINBOCKEL, Augsburg (DE)

(21) Appl. No.: 18/880,427

(22) PCT Filed: Jul. 4, 2023
(86) PCT No.: PCT/EP2023/068321

§ 371 Date: Dec. 31, 2024

(30) Foreign Application Priority Data
Sep. 9, 2022 (DE) 10 2022 123 048.1

(51) Int. Cl. H04R 17/02; B60R 11/02; H04R 1/08

(52) U.S. Cl. CPC H04R 17/025; B60R 11/0247; H04R 1/083; H04R 2201/021; H04R 2499/13

(57) ABSTRACT

The present disclosure relates to a vehicle component, wherein the vehicle component has a surface which is at least partly made of a textile fabric, and at least one piezoelectric transducer fiber is introduced into the textile fabric. The piezoelectric transducer fiber is designed to output an electric signal which indicates an acoustic sound. The vehicle component also has a control unit which is electrically connected to the at least one piezoelectric transducer fiber and is designed to analyze the signal output by the at least one piezoelectric transducer fiber with respect to acoustic information.

### BACKGROUND AND SUMMARY

In modern vehicles, microphones are able to be provided at different locations in the vehicle. By way of example, microphones may be part of a hands-free device that allows the vehicle user to make telephone calls without manually operating a mobile telecommunication terminal. Microphones may also be attached to other locations in the vehicle, for example in order to pick up a noise being produced at mechanical components of the vehicle or noises indicating a fault.

One disadvantage of using microphones in the interior of the vehicle is that, even if the microphones are visually integrated as much as possible (for example into the roof liner of a vehicle or into other vehicle components), these are always visible or perceptible for the vehicle user.

It is sought to design vehicle functions in a vehicle in such a way that they perform their technical function and also allow familiar operation for the user, but their technical character is not perceptible or in the foreground. Therefore, a vehicle function may, for example, only appear and be noticeable by the user if it is operated or intended to be operated. Other technical functions should no longer be perceptible by the user of a vehicle. This is also known under the phrase “shy tech”. Therefore, for example, the microphones visible in/on the vehicle should also be replaced by alternatives that are not perceptible by the vehicle user.

The invention is therefore based on the objective of providing a vehicle component that allows acoustic signals to be picked up and enables better visual integration into a vehicle component.

The invention provides a solution to this according to the independent claims. Developments of the claims are the subject matter of the dependent claims.

In a first aspect, a vehicle component is provided, comprising a surface that is preferably at least partially formed by a textile sheet-like structure, wherein at least one piezoelectric transducer fiber is introduced into the surface, preferably the textile sheet-like structure, wherein the piezoelectric transducer fiber is configured to generate an electrical signal that indicates an acoustic sound, and wherein the at least one piezoelectric transducer fiber is electrically connected to a control unit that is configured to evaluate a signal that is generated by the at least one piezoelectric transducer fiber and relates to an item of acoustic information.

The vehicle component may in particular be a roof liner, a vehicle seat, a trim part and/or an insulating mat or a part thereof in each case.

The in particular flat vehicle component may have at least two audio recording zones in which in each case a plurality of piezoelectric transducer fibers may preferably be introduced.

The control unit may evaluate the signal that is generated by the at least one piezoelectric transducer fiber and relates to an item of voice information.

The control unit may compare the signal output by the at least one piezoelectric transducer fiber with a provided signal and identify whether the output signal deviates from the provided signal.

The control unit may compare a profile of the signal output by the at least one piezoelectric transducer fiber with a provided signal profile. The control unit may generate an output signal if a deviation is identified.

The control unit may evaluate the signal that is output by the at least one piezoelectric transducer fiber and relates to an interfering noise.

In a further aspect, a vehicle comprising a vehicle component is provided, as is described herein.

### BRIEF DESCRIPTION OF THE DRAWINGS

The invention will now also be described with reference to the figures, in which:

FIGS. 1a to c show exemplary embodiments according to the invention,

FIG. 2 shows a further exemplary embodiment according to the invention.

### DETAILED DESCRIPTION OF THE DRAWINGS

The invention makes use of the development of electrically active fibers. In particular, at least one piezoelectric fiber, preferably a plurality of piezoelectric fibers, which are known as transducer fibers, is/are introduced into a surface of a vehicle component. In particular, the surface is a textile sheet-like structure.

The at least one transducer fiber may in particular be woven into a material. The piezoelectric transducer fiber may in particular be an elastic polymer fiber that is able to convert mechanical movements into electrical voltage pulses. In addition, piezoelectric nanocrystals, in particular of barium titanate, are introduced into the fibers or the piezopolymer of the fibers. Further electrical conductors, in particular copper wires as electrodes, are added to the piezoelectric fiber thus adapted and are used to output an electrical signal from the transducer fibers.

If the surface of a vehicle component is at least partially formed with the at least one piezoelectric transducer fiber, it can be used as a microphone. By way of example, the at least one transducer fiber is able to be used to convert sound waves in a frequency range of between 200 and 1000 Hz into voltage pulses, which are dependent on the loudness of the noise, by way of a movement of the at least one transducer fiber. These voltage pulses may then be evaluated by a control unit connected to the at least one transducer fiber. The control unit may therefore record and process an item of acoustic information.

In particular, textile surfaces may be provided at many locations in a vehicle.

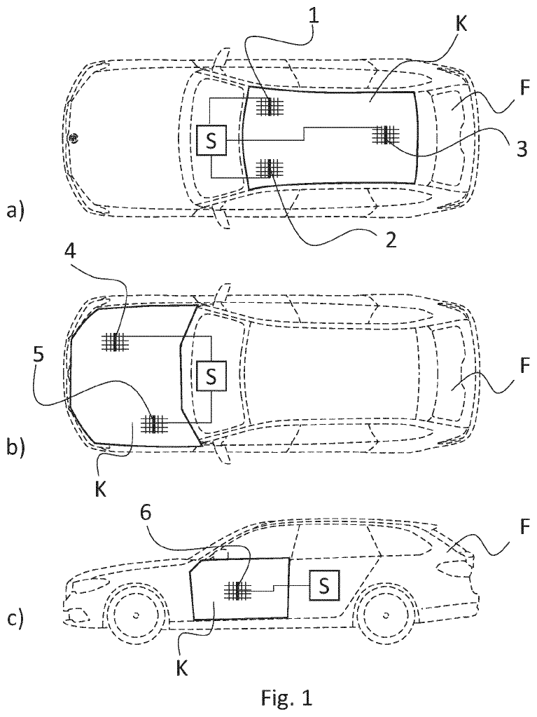

FIG. 1a shows, as an example of a vehicle component K, a roof liner of a vehicle F in which piezoelectric transducer fibers are introduced at different locations. By way of example, at least one acoustically activatable piezoelectric transducer fiber may be introduced in a first region 1 (for illustration purposes, the transducer fiber is illustrated in the figures as a thicker line in a textile structure made of a plurality of fibers in a grid arrangement) above a vehicle user, e.g. the driver, or in a second region 2 above the passenger, in order to thus record acoustic vibrations that are generated by the driver or passenger of the vehicle For the respective vehicle user.

The voltage pulses output by the at least one transducer fiber may then be evaluated by a control unit S with regard to an item of acoustic information. The control unit S may, for example on the basis of the item of acoustic information, then change settings of the vehicle F or output control signals to other control units in the vehicle.

A region in the vehicle component K into which an acoustic transducer fiber is alternatively or additionally introduced may also be provided in a third region 3, for example in the back. It should be understood in this case that the transducer fibers are also able to be used in addition to conventional microphones, wherein the microphones may, however, be placed in more hidden positions in the vehicle interior.

FIG. 1b shows the arrangement of a surface, in particular of a textile structure, in a fourth region 4 and in a fifth region 5 of an engine compartment of the vehicle F. It should be understood in this case that, by way of example here, a part of the vehicle F is provided with a vehicle component K, said part having mechanical components accommodated therein and in particular being understood to not be an interior or a passenger compartment of the vehicle F. A surface, for example an interior trim, as the vehicle component K, may also be provided with a piezoelectric transducer fiber here. By way of example, noise in the region of a mechanical component may therefore be recorded and evaluated by the control unit S.

The recorded item of acoustic information that is evaluated by the control unit S is in particular used to compare a noise generated by a mechanical or electrical component with a target noise. It is therefore able to be established if a recorded noise differs from a target noise. By way of example, this may be an indication of a faulty mechanical or electrical component and, for example, a warning may therefore be output to a vehicle user that the electrical or mechanical component should be checked.

FIG. 1c shows a further exemplary application according to the invention. In this case, a surface of a vehicle component K, for example a textile structure, is, by way of example, fitted in a sixth region 6 of an interior trim of a vehicle door of the vehicle F. The surface in the vehicle door may have a piezoelectric transducer fiber, wherein the surface is exposed to the passenger compartment. Therefore, an acoustic signal that is generated by a vehicle user may also be recorded here by the transducer fiber and be evaluated by a control unit S with regard to an item of acoustic information, for example a voice signal.

Provision may also be made for the control unit S to record and evaluate signals from all the piezoelectric transducer fibers and/or from transducer fibers in the regions 1-6 out of a plurality of regions. In particular, the control unit may record and evaluate the voltage pulses generated by different piezoelectric transducer fibers in a correlated manner. It is therefore possible to ensure higher recognition accuracy of the item of acoustic information. The at least one transducer fiber may, of course, also be provided in other surfaces or textile structures of the vehicle F that do not correspond to the regions 1-6.

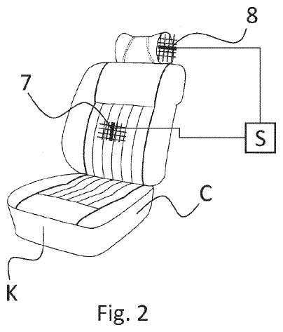

FIG. 2 shows yet another embodiment according to the invention. In this case, a seat C is shown by way of example as the vehicle component K. In the seat C, at least one piezoelectric transducer fiber 7 may be incorporated into the backrest, for example. By way of example, the transducer fiber 7 may be provided to record a vital function of the seat user, in particular an item of acoustic information concerning the heartbeat of the seat user or other vital functions that cause an excitation of the at least one piezoelectric transducer fiber. The control unit S may in turn evaluate the voltage pulses output by the at least one transducer fiber. The evaluation with respect to the item of acoustic information is carried out with regard to the vital functions.

In FIG. 2, by way of example, on the seat C, a further region 8 is provided with at least one piezoelectric transducer fiber on the headrest. In this case, too, an acoustic signal is recorded by the at least one piezoelectric transducer fiber that is introduced into a surface of the seat. The control unit S evaluates the signal from the at least one piezoelectric transducer fiber with regard to an item of acoustic information.

The surface is in particular a textile sheet-like structure. The surface of the vehicle component K, which is in particular at least partially formed by the textile sheet-like structure, is designed in such a way that the sound output by the sound source to be monitored is able to be recorded by the at least one piezoelectric transducer fiber.

It should also be understood, however, that the at least one transducer fiber may be introduced into other surface structures, for example into synthetic materials, as long as it is ensured that the at least one piezoelectric transducer fiber is able to be excited and is able to output voltage pulses that reproduce acoustic information. It is therefore possible, for example, to introduce the transducer fibers into textile upper materials, but also into synthetic leather, for example. In addition, the at least one transducer fiber may be used as part of threads or yarns, for example, that are configured to connect parts of component surfaces, for example parts of seat covers.

1-8. (canceled)

9. A vehicle component, comprising:
a surface that is at least partially formed by a textile sheet-like structure, wherein at least one piezoelectric transducer fiber is introduced into the surface;
wherein the piezoelectric transducer fiber is configured to generate an electrical signal that indicates an acoustic sound; and
wherein the at least one piezoelectric transducer fiber is electrically connected to a control unit that is configured to evaluate a signal that is generated by the at least one piezoelectric transducer fiber as it relates to an item of acoustic information.

10. The vehicle component according to claim 9, wherein the vehicle component is at least one of a roof liner, a vehicle seat, a trim part or an insulating mat.

11. The vehicle component according to claim 9, wherein the vehicle component has at least two audio recording zones, wherein in each audio recording zone a plurality of piezoelectric transducer fibers are introduced.

12. The vehicle component according to claim 9, wherein the control unit is configured to evaluate the signal that is generated by the at least one piezoelectric transducer fiber as it relates to an item of voice information.

13. The vehicle component according to claim 9, wherein the control unit is configured to compare the signal output by the at least one piezoelectric transducer fiber with a provided signal and to identify whether the output signal deviates from the provided signal.

14. The vehicle component according to claim 9, wherein the control unit is configured to:
compare a profile of the signal output by the at least one piezoelectric transducer fiber with a provided signal profile, and
generates an output signal when a deviation is identified.

15. The vehicle component according to claim 9, wherein the control unit is configured to evaluate the signal that is output by the at least one piezoelectric transducer fiber as it relates to an interfering noise.

16. A vehicle comprising a vehicle component according to claim 9.
